(19) United States
(12) Patent Application Publication
(10) Pub. No.: US 2013/0101255 A1
(43) Pub. Date: Apr. 25, 2013

(54) LASER CONCENTRATING WAVEGUIDE DEVICE

(71) Applicant: William Klimowych, Greenville, SC (US)

(72) Inventor: William Klimowych, Greenville, SC (US)

(73) Assignee: AFL TELECOMMUNICATIONS LLC, Duncan (US)

(21) Appl. No.: 13/577,795

(22) PCT Filed: Apr. 12, 2012
(86) PCT No.: PCT/US12/33211

§ 371 Date: Aug. 8, 2012

Related U.S. Application Data
(60) Provisional application No. 61/474,421, filed on Apr. 12, 2011.

(51) Int. Cl. G02B 6/26

(52) U.S. Cl. CPC G02B 6/26
USPC 385/50

(57) ABSTRACT

A concentrator waveguide device is provided including a coupler having an interior passage therein which tapers from an input end of the coupler to an output end of the coupler, such that a cross-sectional area of an input end of the interior passage is larger than a cross-sectional area of an output end of the interior passage, wherein walls of the interior passage of the coupler are reflective; and a waveguide having an interior passage therein, wherein the waveguide is disposed such that light output from the output end of the interior passage of the coupler is incident into an input end of the interior passage of the waveguide, wherein walls of the interior passage of the waveguide are reflective.

### CROSS-REFERENCE TO RELATED PATENT APPLICATION

This Application claims the benefit of U.S. Provisional Application No. 61/474,421, filed Apr. 12, 2011 in the United States patent and Trademark Office, the disclosure of which is incorporated herein in its entirety by reference.

### BACKGROUND

1. Field

Apparatuses and methods consistent with exemplary embodiments related to a concentrator waveguide device for use with far infrared laser light.

2. Description of the Related Art

Far infrared laser light is used in many fields for many applications such as in precision materials processing for the processing, cutting, and fusion splicing of fiber optics devices, or the processing, fusing, ablating, or cutting of other glass materials or metal materials.

### SUMMARY

A concentrator waveguide device is provided including a coupler having an interior passage therein which tapers from an input end of the coupler to an output end of the coupler, such that a cross-sectional area of an input end of the interior passage is larger than a cross-sectional area of an output end of the interior passage, wherein walls of the interior passage of the coupler are reflective; and a waveguide having an interior passage therein, wherein the waveguide is disposed such that light output from the output end of the interior passage of the coupler is incident into an input end of the interior passage of the waveguide, wherein walls of the interior passage of the waveguide are reflective.

The coupler and the waveguide may be made of copper or brass.

The interior passage of the waveguide may be tapered such that a cross-sectional area of the input end of the interior passage of the waveguide is larger than a cross-sectional area of an output end of the interior passage of the coupler.

### BRIEF DESCRIPTION OF THE DRAWINGS

FIG. 1 illustrates a concentrator waveguide device according to an exemplary embodiment.

### DETAILED DESCRIPTION

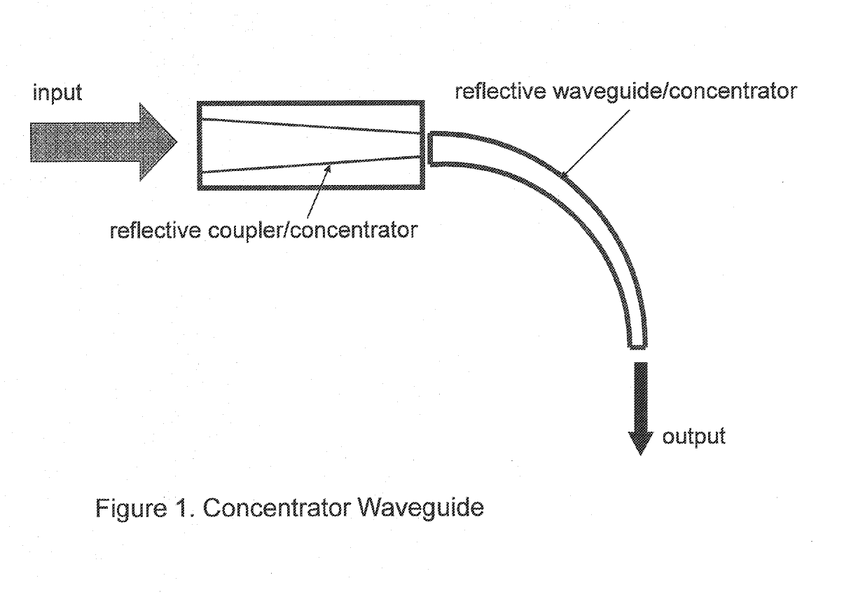

FIG. 1 illustrates a concentrator waveguide device according to an exemplary embodiment. The concentrator waveguide device comprises a coupler and a waveguide which guide and concentrate light input therein to a concentrated spot. The coupler and the waveguide have highly reflective internal walls, defining interior passages, which reflect the light therewithin. The coupler and the waveguide may be made of copper or brass or another metal material as would be understood by one of skill in the art. The coupler and the waveguide may be made of different materials from each other.

The interior walls of the coupler and waveguide are highly polished so as to reflect incident light therefrom. Alternately, the interior walls of one or both of the coupler and the waveguide may have a reflective coating formed thereon.

A cross-section of the interior passages of the coupler and waveguide may be circular or another shape as would be understood by one of skill in the art. The coupler and the √ may have different interior cross sectional shapes.

The interior passage of the coupler is tapered from an input end (on the left as shown in FIG. 1) to an opposite output end (to the right as shown in FIG. 1), such that a cross section of an input end of the interior passage is larger than a cross section of an output end of the interior passage. The taper of the interior passage may be substantially continuous, or may be discontinuous. The interior passage of the waveguide may have a uniform cross-sectional area, or may be tapered from an input end to an output end thereof, as shown in FIG. 1. The taper of the interior passage of the waveguide may be substantially continuous or may be discontinuous.

The interior passage of the waveguide may be substantially straight or may be curved or bent such that an input direction, which is substantially normal to a cross section of the input end may form an angle with an output direction which is substantially normal to a cross section of the output end.

The waveguide may be flexible such that the output end thereof may be moveable with respect to the input end thereof.

An area of the cross section of the output end of the interior passage of the coupler is equal to or larger than an area of the cross section of the input end of the interior passage of the waveguide, and the waveguide is positioned such that light output from the coupler is incident into the interior passage of the waveguide.

Due to the taper of the concentrator or of the concentrator and the waveguide, light which passes through the concentrator waveguide device is concentrated and there is an increased power density of light output from the concentrator waveguide device as compared to light input into the concentrator waveguide device.

The concentrator waveguide device may be used to concentrate and guide far infrared light, such as light having a wavelength of 10.6 μm or 9.6 μm. Alternately, the concentrator waveguide may be used to guide light of near infrared or another infrared wavelength or light having a visible wavelength.

The light output from the concentrator waveguide device may be used in precision materials processing such as in the, cutting, and fusion splicing of fiber optics, or the, fusing, ablating, or cutting of other glass materials or metal materials.

One advantage of the concentrator waveguide device is the efficient use of space to guide light to a specific point using a small profile coupler and waveguide without the use of bulk optics. Additionally, as the concentrator waveguide device is made of materials opaque to the light, the provide additional safety to those working with the device by enclosing the light therewithin.

What is claimed is:

1. A concentrator waveguide device comprising:
a coupler having an interior passage therein which tapers from an input end of the coupler to an output end of the coupler, such that a cross-sectional area of an input end of the interior passage is larger than a cross-sectional area of an output end of the interior passage, wherein walls of the interior passage of the coupler are reflective; and
a waveguide having an interior passage therein, wherein the waveguide is disposed such that light output from the output end of the interior passage of the coupler is incident into an input end of the interior passage of the waveguide, wherein walls of the interior passage of the waveguide are reflective.

2. The device according to claim 1, wherein the coupler and the waveguide are formed of copper.

3. The device according to claim 1, wherein the coupler and the waveguide are formed of brass.

4. The device according to claim 2, wherein the interior passage of the waveguide is tapered such that a cross-sectional area of the input end of the interior passage of the waveguide is larger than a cross-sectional area of an output end of the interior passage of the waveguide.

5. The device according to claim 4, wherein the waveguide is bent, such that an optical path along which light enters the input end of the interior passage of the waveguide forms an angle with respect to an optical path along which light exits the output end of the interior passage of the waveguide.

6. The device according to claim 1, wherein walls of the interior passage of the coupler and walls of the interior passage of the waveguide are reflective to far infrared light.

7. A method of guiding far infrared light, the method comprising:
directing the far infrared light into an input end of an interior passage of a copper coupler, wherein the interior passage of the coupler tapers from the input end to an output end of the interior passage of the coupler, such that a cross-sectional area of an input end of the interior passage is larger than a cross-sectional area of an output end of the interior passage;
reflecting the far infrared light off walls of the interior passage of the coupler, such that the light is output from the coupler and is incident into an input end of an interior passage of a waveguide; and
reflecting the far infrared light off walls of the interior passage of the copper waveguide.
